(19) United States
(12) Patent Application Publication
(10) Pub. No.: US 2009/0161844 A1
(43) Pub. Date: Jun. 25, 2009

(54) COMMUNICATIONS METHOD WITH TRANSMISSION OF ADDITIONAL INFORMATION

(75) Inventor: Michael Bachenberg, Duesseldorf (DE)

Correspondence Address: DARBY & DARBY P.C., P.O. BOX 770, Church Street Station, New York, NY, 10008-0770, US

(73) Assignee: PIXCALL GMBH, Duesseldorf (DE)

(21) Appl. No.: 11/815,898

(22) PCT Filed: Feb. 10, 2006
(86) PCT No.: PCT/DE06/00233

§ 371 Date: Jun. 10, 2008

(30) Foreign Application Priority Data
Feb. 10, 2005 (DE) 10 2005 006 331.4

(51) Int. Cl. H04M 11/00

(52) U.S. Cl. 379/93.12; 379/93.01

(57) ABSTRACT

A communications method for transmitting additional information relating to a call process using a first subscriber's station to set up a communications context with a second subscriber's station for the transmission of data or information. Additional information including at least one of audio, image and video data is transmitted to the second subscriber's station. The additional information is defined by the first subscriber's station and is transmitted to the second subscriber station before or during the call process. The additional information is output on the second subscriber's station in the form of a signal for indicating the call.

### CROSS-REFERENCE TO PRIOR APPLICATIONS

This application is a U.S. National Phase application under 35 U.S.C. § 371 of International Application No. PCT/DE2006/000233, filed on Feb. 10, 2006 and claims benefit to German Patent Application No. DE 10 2005 006 331.4, filed on Feb. 10, 2005. The International Application was published in German on Aug. 17, 2006 as WO 2006/084451 under PCT Article 21 (2).

The present invention relates to a communication method with transmission of additional information, during which a call process is carried out by means of a first subscriber station in order to set up a communication context with a second subscriber station for the transfer of data or information, and additional information containing the audio, image or video data or control data is transmitted to the second subscriber station.

### BACKGROUND

Information of different types, which for example contains, speech, visual information, video information or in general multimedia information, can be transferred between the subscriber stations of a communication system, for example, telephones, mobile phones, PDAs, computers, etc. in case of usual communication methods. The transmission of additional information plays a very important role in this process. For example, additional information can be transmitted to the subscribers in the form of an advertisement in order to reduce the communication costs for the subscribers.

There is the requirement especially for the subscribers of modern communication systems to send individual audio, image or video data to other subscribers, to transmit personal multimedia-based messages. This requirement exists both in the private domain as well as in the business domain, in which, for example, an image of the caller or an audio or video file associated with the caller is transmitted to one or more subscribers as additional information.

### SUMMARY OF THE INVENTION

An aspect of the present invention is to provide a communication method, which has an added attraction both for the subscribers as well as for the advertisers to increase its usage.

The present invention provides a method for communicating with transmission of additional information.

In case of the communication method according to the invention with transmission of additional information, a call process is carried out by means of a first subscriber station in order to set up a communication context with a second subscriber station for the transfer of data or information and, further, additional information is transmitted to the second subscriber station, which include audio, image or video data, in which the additional information is defined by the first subscriber station and transmitted to the second subscriber station already before or during the call process and the additional information is outputted to the second subscriber station as a signal for the indication of the call.

Thus, the called subscriber can recognize multimedia-based information of the caller already before receiving the call, such as a personal visiting card or a personal ring tone of the caller, which is outputted for the called subscriber. Consequently, the called subscriber has a better option to decide whether he should receive this call or not. Especially, the caller can specify the ring tone, which is generated for the called subscriber through the communication process according to the invention. Since each calling signal can be formed individually by the caller and ensures an individual appearance for the called subscriber, it is an added attraction for the subscribers.

Further, the transmission of the additional information can be accounted for separately by the service provider. The additional information can, for example, also contain advertising messages, where the advertisers bear the communication costs totally or partially and the subscribers can use the communication service with favorable terms or lower costs.

For example, the additional information can be transmitted going out from the first subscriber station to the second subscriber station. An advantage of this alternative is that the additional information is created at the first subscriber station and transmitted directly going out from there to the second subscriber station as calling signal.

Alternatively, the additional information can be retrieved from a data storage linked to the second subscriber station through a control signal going out from the first subscriber station. This variant has the advantage that no large quantities of data have to be stored in the first subscriber station and, further, no large quantities of data have to be transferred from the first subscriber station to the second subscriber station.

Advantageously, the additional information may be selected from a number of stored templates by means of the first subscriber station. Thus the calling subscriber can provide the additional information quickly for the dispatch. For that, the additional information can be stored in a central data server of the communication system or locally in storage of the subscriber station.

The additional information can be created also by means of the first subscriber station. Thus a subscriber can, for example, dispatch currently created images or videos or even sound recordings as additional information to the second subscriber, which signal the incoming call to the second subscriber.

Preferably, the additional information is modified by means of the first subscriber station in order to transmit individual messages of the first subscriber station in the additional information. Thus advertising messages can be linked to personal messages of the calling subscriber as additional information so that the advertising message appears as a calling signal to the second subscriber station or for the called subscriber, together with the personal message of the caller.

Advantageously, it is automatically checked before the signaling of the additional information at the second subscriber station whether the signaling of the additional information is permitted or prevented. Thus, the called subscriber can ensure that he is not harassed by undesired additional information, for example, undesired ring tones. Preferably, the process offers the possibility to permit special or incoming, individual ring tones only at certain times, for example only outside the working hours of the called subscriber. Also, the authorization can refer to certain callers, such as to callers or caller groups, whose numbers are stored in the address book of the called subscriber. Further, the authorization for the signaling of the additional information can refer only to special callers, for whom one has explicitly permitted the signaling of their additional information to the own subscriber station.

Preferably, the additional information is stored in a data storage assigned to the second subscriber station and outputted as calling signal for future incoming calls. Thus additional information of certain subscriber, for example a certain individual ring tone of the caller and/or a multimedia-based visiting card shown on a display, are signaled again and again as the calling signal for the call receiver, if this subscriber calls up or desires to set up a communication context with the subscriber station of the call receiver.

The additional information can also comprise a purchase offer, which is outputted to the second subscriber station, and a signal can be sent to a central data processing unit of the communication system by the second subscriber station for the acceptance of the purchase offer.

Thus, products and services can be acquired directly and in a simple manner. That means, a called subscriber can respond directly to the additional information provided as an advertisement and acquire the desired product. The advertiser gets the advantage of a specially targeted and effective advertisement.

Advantageously, after the dispatch of the signal for the acceptance of the purchase offer, a signal is generated for the release of the additional information for use by the second subscriber station. Thus, the second subscriber can, for example, acquire particularly attractive additional information, which he can then use himself in order to notify his calls to other subscribers. That is, the called subscriber can acquire especially melodies, video sequences or images in order to use as calling signals for his own future calls. An increased fun factor is achieved by this means for the subscribers, which exceeds very much the till now known usage of ring tones in one's own device. Thereby, considerable economical advantages arise both for the operators of the communication service as well as for the vendors of music and video files.

Preferably, a signal is generated with a reduction in fees after the dispatch of the signal for the acceptance of the purchase offer and assigned to a subscriber station, particularly to the second subscriber station. Thus, the purchase of a product can appear still more attractive for the subscriber, since he receives a bonus for the use of the communication service, if he concludes the purchase.

The additional information can be transmitted to the second subscriber station before a call signaling via data transfer. This has the special advantage of using already existing valid standards while call signaling and transmission of the ring tone.

The additional information can also be transmitted to the second subscriber station together with the call signaling. Thereby, the ring tone or the individual audio ringing signal arrives always synchronously with the incoming call. Further, an invoicing is made possible since the additional information or even the control information, which is dispatched with the call signaling, can be evaluated with a switching device.

Preferably, a control signal is transmitted to the second subscriber station in the call signaling, which is interpreted at the second subscriber station by means of a comparator, in order to output the additional information. This process offers likewise advantages for the invoicing, since the control information, which is dispatched with the call signaling, can be evaluated with a switching device. For this purpose, the control signal is extracted in the switching device and transmitted to an accounting system.

According to an advantageous embodiment of the communication method, a control signal is transmitted to the second subscriber station with the call signaling and analyzed at the second subscriber station in order to select audio, image or video data from a data storage and to output as signal for the display of an incoming call.

For example, multimedia-based additional information or even a ring tone etc. can be selected from a database at the first subscriber station, to which a control signal is assigned. In this case, only the control signal is transmitted, which leads to the extraction of a corresponding additional information from a database of the second subscriber station on receipt at the second subscriber station, whereby the additional information extracted corresponding to the transmitted control signal appears as the ringing signal for the signaling of the call arriving at the second subscriber station. An accurate invoicing is also possible for this process, if the control information, which is dispatched with the call signaling, is evaluated at the switching device.

Also, this example has the advantage that no large quantities of data have to be transmitted, such as audio data as ring tones etc. Therefore, this method can be implemented with reduced expenditure.

Advantageously, a number of additional information is stored in the first and/or in the second subscriber station, in which the additional information can be updated at timely intervals through a central data server of the communication system. In this way, the latest ring tones or audio data or even visual information or data can always be offered to the user, since the offer can be regularly updated via the data server. Further, an accurate invoicing is also possible if the control information, which is dispatched with the call signaling, is evaluated at a switching device. In addition to that, no large data packets have to be transmitted in this case also for the execution of the method according to the invention, i.e., the method according to the invention can be implemented with relatively low expenditure.

Preferably, a query signal is sent to the second subscriber station before the transmission of the control signal to the second subscriber station, which causes the transmission of a selection information for the selection of possible audio, image or video information to the first subscriber station, and a selection is made afterwards by means of the first subscriber station and a control signal corresponding to the selection is transmitted to the second subscriber station.

Thereby, the called subscriber can himself determine which types of ring tones or in general audio or video data he would like to receive as call signaling. That means the called subscriber dispatches a possible selection to the calling subscriber so that he can select from the corresponding offer. An accurate invoicing is also possible for this form, since the control information, which is dispatched with the call signaling, can be evaluated at a switching device. In addition, no large data packets have to be transmitted for this form of method and consequently the method can also be implemented with reduced expenditure.

This method can be used advantageously in speech dialog systems (speech portals) in order to give the user an improved navigation through the speech dialog system with the additional information placed for the selection.

Advantageously, the additional information is transmitted from the central data server of the communication system to the second subscriber station, for which a calling signal is sent from the first subscriber station to the central data server beforehand. Thus, always the latest ring tones or signaling files or general cards can be offered to the user easily for the ring signaling since the offer is always retrieved from the server. An accurate invoicing is also possible through the server-based system.

Preferably, the transmission of a selection signal from the central data server to the first subscriber station is triggered by the receipt of the query signal in the central data server, which selection signal enables at the first subscriber station the selection of an additional information about the second subscriber station, and a trigger signal is sent afterwards for the triggering of the transmission of the selected additional information from the first subscriber station to the central data server, which causes the transmission of the additional information to the second subscriber station. An advantage offered to the user is that a current selection of existing additional information is provided, from which he or she can select the suitable additional information in order to use it as ring signal for the called subscriber. Here also, an accurate invoicing option is offered based on a server-based system.

Advantageously, the additional information is sent from the central data server to the second subscriber station together with an identity of the first subscriber station. In addition, a call signaling is sent from the first subscriber station to the second subscriber station, in which the additional information is outputted at the second subscriber station as signal for an incoming call especially after receiving the call signaling.

Already existing valid standards can be used by this measure for the call signaling and for the transmission of the ring tone. The charging of the calls with signaling through additional information can be implemented through a specific tax metering. Particularly, additional information can also be provided by a specific service provider. An own server can also be operated, which implements the messages.

### BRIEF DESCRIPTION OF THE DRAWINGS

The invention is exemplified below based on the figures, in which

FIG. 1 represents schematically a flow chart of the method according to the invention by way of an example of a mobile telephony connection;

FIG. 2 shows a flow chart, in which further details of the method according to the invention are represented according to the first embodiment;

FIG. 3 shows a further embodiment of the method according to the invention, by which the additional information occurs before the call signaling by data transfer;

FIG. 4 shows a further embodiment of the method according to the invention, by which the additional information is transmitted with the call signaling or in the call signaling;

FIG. 5 shows a further embodiment of the method according to the invention, by which the dispatch of the additional information occurs before the call signaling by data transfer;

FIG. 6 shows a further embodiment of the method according to the invention, by which the additional information is present in the storage of both subscriber stations and control information is transmitted in the call signaling;

FIG. 7 shows a further embodiment of the method according to the invention, by which the additional information is updated in the storage of the subscriber stations from a data server;

FIG. 8 shows a further embodiment of the method according to the invention, by which the called subscriber station provides a selection of possible additional information for the first subscriber station;

FIG. 9 shows a further embodiment of the method according to the invention, by which the additional information is already stored on a central data server before the call signaling; and

FIG. 10 shows a further embodiment of the method according to the invention, by which the additional information is dispatched before the call signaling from first subscriber station to second subscriber station via a data server.

### DETAILED DESCRIPTION

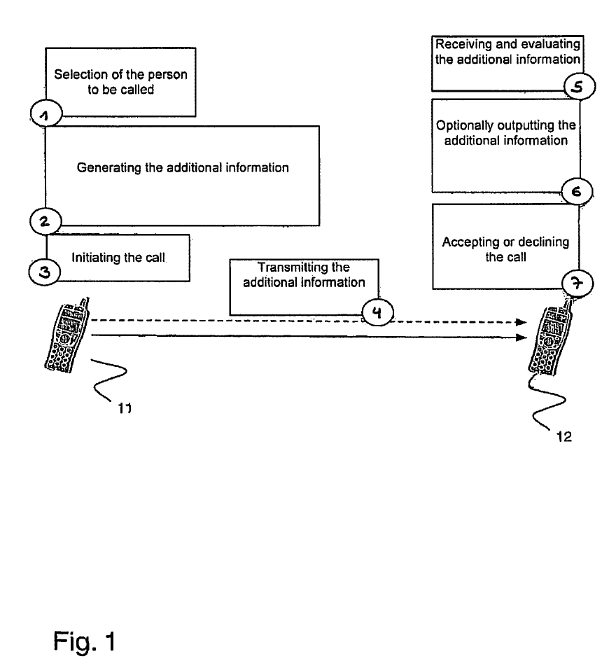

FIG. 1 shows a first embodiment of the method according to the invention. At first, the desired conversation partner is selected at a first subscriber station 11, for example, a mobile radio unit or terminal, through entry of the call identifier or through selection from an address book (Step 1). Afterwards, additional information is created. This can take place through selection of a ring tone, video, animation or other multimedia-based data. But, the additional information can also be created on picking up of a ring tone, video or through selection of wallpaper, video or animation and entering a personal message (Step 2). Afterwards, the calling process is started (Step 3). In this embodiment, the transmitting of the additional information takes place during or before the calling process (Step 4).

The additional information is received and evaluated at the second subscriber station 12, which, for example, is also a mobile phone (Step 5). If an option for the output of the transmitted additional information is activated at the second subscriber station, these are outputted instead of the preset ring tone or image or video (Step 6). Now, the called subscriber at the second subscriber station 12 can decide whether he or she receives the call or refuses based on the outputted additional information (Step 7).

Consequently, the caller at the first subscriber station 11 can determine the ring tone or the displayed or played additional information for the called subscriber at the subscriber station 12 and personalize the calling. The called subscriber at the second subscriber station 12 can easily decide whether he wants to receive the call through the additional information. The additional information can be accounted separately by the vendor of the communication service.

In order to prevent the harassing of the called subscriber at the subscriber station 12 by undesired ring tones, audio signaling or similar, authorization data are contained in the second subscriber station 12 in a comparator memory. The authorization data contains information on calling times, special ring tones, callers or caller groups or numbers in the address book. For an incoming call, the calling data or the times are compared with these data in the comparator and the output of the additional information at the second subscriber station 12 is permitted or prevented according to that.

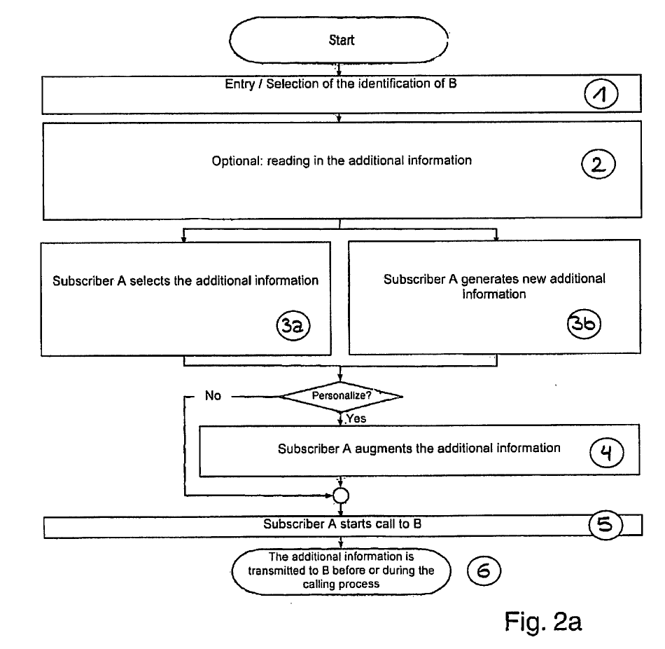

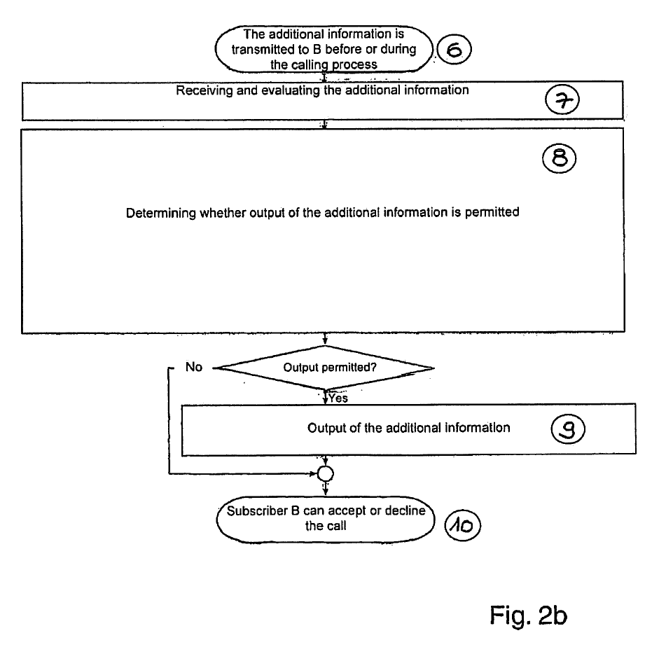

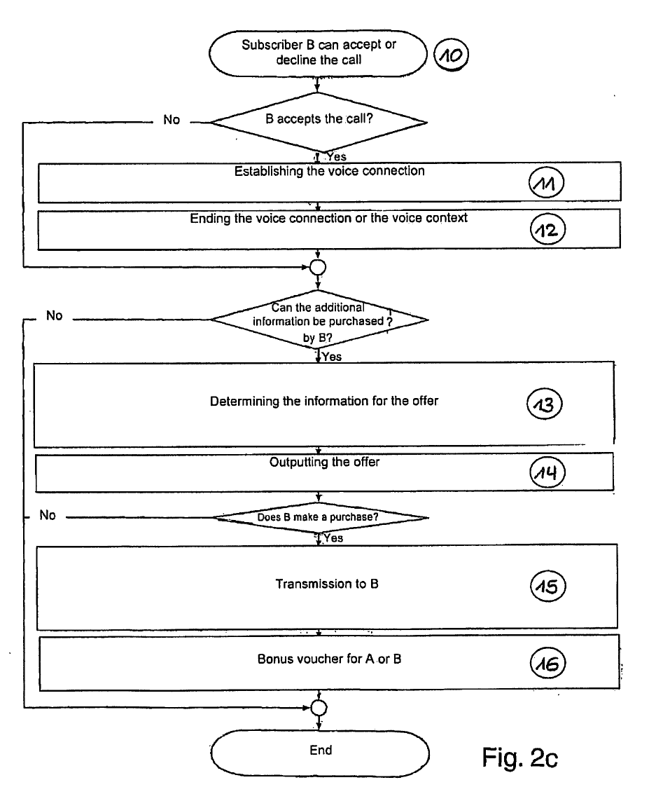

FIG. 2a shows further details of the first embodiment from the start of the process up to the transmission of the additional information. After the start of the process, the subscriber A enters an identity of the subscriber B at the first subscriber station 11 or selects B from his address book (Step 1).

In the next step (Step 2), the additional information available for the selection, for example, a ring tone or information on this additional information, e.g., the name of the ring tone, the file type or an audio sample, is either selected from storage or created new. For that, the additional information can be read in from storage of the first subscriber station 11 or from the storage of the second subscriber station 12 or from an external server. If the additional information has to be created new, nothing is read in.

The subscriber A at the first subscriber station 11 can now execute either step 3a or step 3b. In step 3a, the subscriber A selects additional information. The selection occurs either from the own additional information, for example, own ring tones or data cards, or from a special offer for additional information, like, specially released ring tones or data cards. Subscriber A can also select the additional information from a special selection of the subscriber B. Alternatively, the subscriber A creates a new additional information, for example, by recording an own ring tone or by creating an own image or text message (Step 3b).

The subscriber A can now optionally further personalize the additional information. For that, the subscriber A supplements the selected or created additional information through indication or incorporation or modification of the additional information through entry of a text message in a selected data card for the display (Step 4).

Now, the subscriber A at the first subscriber station 11 starts the calling to the subscriber B at the second subscriber station 12 (Step 5). Afterwards, the additional information is transmitted to the subscriber B at the second subscriber station 12 before or during the calling process (Step 6).

The process flow of the steps shown above can also occur in another sequence, i.e., for example, first the additional information are compiled and then the subscriber B to be called up is selected.

FIG. 2b shows in detail the further process steps from the transmission of the additional information up to the output to the second subscriber station 12. After the transmission of the additional information to the second subscriber station 12, the additional information is received at the second subscriber station and evaluated (Step 7).

Afterwards, it is determined whether the outputting of the received additional information is permitted (Step 8). This takes place through comparison of the call identifier of the subscriber A with presettings at the second subscriber station 12. Besides, the authorization depends on one or more of the following factors:
a) general authorization, i.e., the additional information is always outputted,
b) association of the call identifier to the address book,
c) association of the call identifier to a category or group,
d) specific setting for the call identifier,
e) time of the receipt of the call, (for example, the additional information should be received only in the evening),
f) status of the subscriber station 12 or the current environment parameters, such as light or noise.

Besides, it can be specified in presettings whether the output of the additional information is totally, partially or not at all permitted respectively (Step 8).

If it is determined through the comparator circuit that the outputting of the additional information is permitted, the additional information of the subscriber A is outputted from the subscriber station 12 of the subscriber B and replace there the presettings at the subscriber station 12, either only for this current calling, or for this current calling and all further callings of the subscriber A (Step 9). The subscriber B can now decide whether he wants to receive the call or refuse (Step 10).

In FIG. 2c, the further process flow of the method according to the invention is represented in detail according to the first embodiment. If the call is received by B, a voice connection or a speech context is produced between the first subscriber station 11 and the second subscriber station 12. Besides, the additional information, for example, an image or video information, can be optionally displayed further (Step 11). Afterwards, the voice connection or the speech context is ended (Step 12).

If additional information was outputted, and which can be acquired from the subscriber B for the second subscriber station 12, the following steps further take place:

The information for the offer are either determined from the received additional information or retrieved from a server. Besides, the offer can contain the acquisition of data and/or authorizations. For example, the played additional information, especially ring tones, images, video clips or data cards, can be acquired. But, objects linked with the additional information, such as a piece of music belonging to the ring tone, a video clip, data or fun cards or fun objects, can also be acquired (Step 13).

Moreover, it is noted that ring tones are freely distributed as advertising medium for music titles or other products. If the subscriber A uses this ring tone to call up the subscriber B, the offer is automatically made to the subscriber B to buy the advertised product.

The output of an offer, for example, to buy the correlated ring tone, occurs on the subscriber station 12 of the subscriber B (Step 14). If the subscriber B wants to accept the offer, the additional information, like ring tones etc. or an additional information plus an activation or clearing information is transmitted e.g. from a server. But, activated additional information, like a ring tone with incorporated authorization, can also be transmitted or the activation occurs only if the additional information was already transmitted and stored, e.g. for DRM systems (Digital Rights Management), which separate contents and authorization (Step 15) as specified by the open mobile alliance.

Finally, a bonus system is instructed by the server to credit a bonus to the subscriber A. The information about the credit is outputted on the subscriber station 11 or the terminal of the subscriber A. (Step 16).

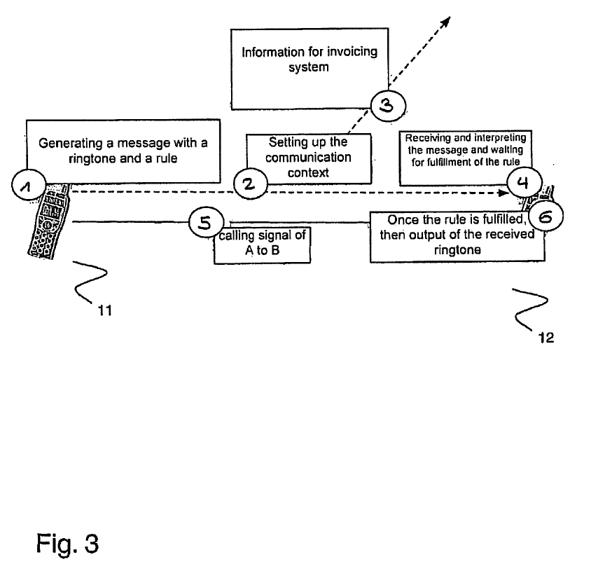

FIG. 3 shows schematically the process flow of the method according to the invention according to a further embodiment. At first, a message is created at the subscriber station 11, e.g. an SMS or MMS, which contains a ring tone and a correlated rule. The rule can be, e.g.: “If the call identifier of the caller is the same as the call identifier of A (thus CLI=A), play the attached ring tone”. (Step 1). Now, a communication context is set up for the data transfer (Step 2).

In step 3, information is determined and created for an invoicing system in a switching device. For that, the switching device contains an SIP Application Server (Session Initiation Protocol Application Server, as available in future mobile telephony systems).

Finally, the receipt and the interpretation of the message occur at the second subscriber station 12. It is retained until the rule, for example CLI=A, is fulfilled (Step 4).

Finally, the call signaling occurs from the first subscriber station 11 to the second subscriber station 12 (Step 5). If the rule is fulfilled, the received ring tone is played once or every time in future at the second subscriber station 12 instead of the standard ring tone. (Step 6).

This method has the advantage that already existing valid standards can be used for the call signaling and for the transmission of the ring tone.

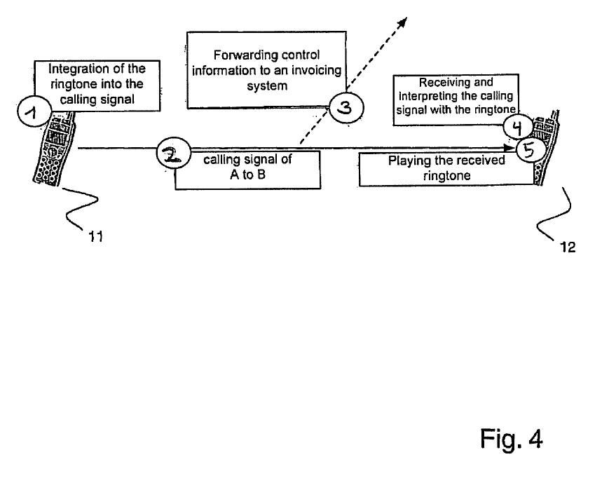

FIG. 4 shows a further possible formation of the method. In this process, at first the integration of the ring tone in the call signaling takes place at the first subscriber station 11, e.g. CLI (Step 1). Now, the call signaling occurs from the first subscriber station 11 to the second subscriber station 12, for example CLI with ring tone (Step 2). The control information is extracted in a switching device and forwarded to the invoicing system (Step 3). Finally, the receipt and the interpretation of the call signaling occur with the ring tone (Step 4). The playing of the received ring tone instead of the preset ring tone occurs at the second subscriber station 12 (Step 5).

An invoicing is possible through this form since the control information, which is dispatched with the call signaling, can be evaluated at a switching device. The ring tone always arrives synchronously with the incoming call.

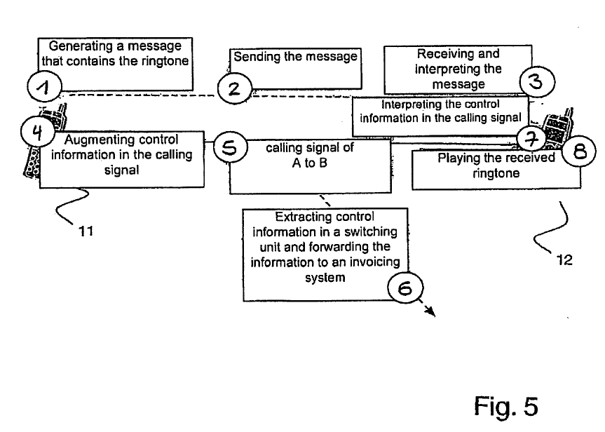

FIG. 5 shows a further possible form of the method. In this process, at first a message is created at the first subscriber station 11, like an SMS or MMS message, which contains a ring tone (Step 1). Now, the created message is dispatched (Step 2). The receipt and the interpretation of the message takes place subsequently (Step 3). An addition of control information takes place in the call signaling at the first subscriber station 11 (Step 4). Finally, the call signaling from the first subscriber station 11 to the second subscriber station 12 takes place, for example, a CLI with a control information (Step 5).

The control information can be extracted in a switching device and forwarded to an invoicing system (Step 6). Now, the interpretation of the control information in the call signaling takes place at the second subscriber station 12 (Step 7). Finally, the playing of the received ring tone takes place at the second subscriber station 12 in place of the preset ring tone (Step 8).

This form of the method also offers the advantage of an exact invoicing since the control information, which is dispatched with the call signaling, can be evaluated at a switching device.

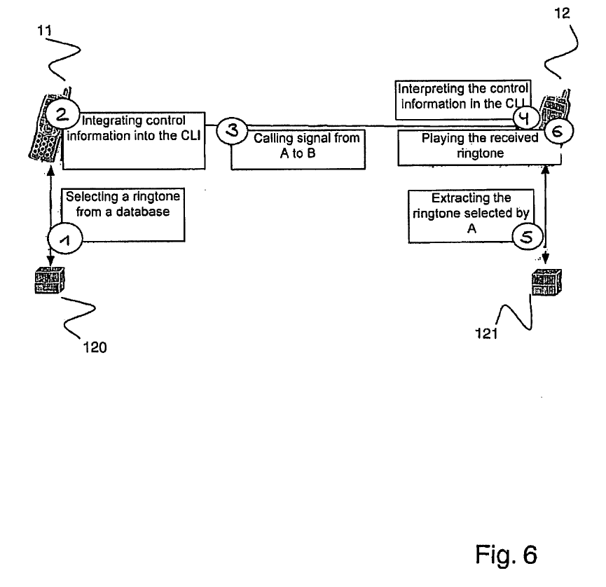

FIG. 6 shows a further advantageous embodiment of the method according to the invention. In this case, a database 120 is assigned to the first subscriber station 11. The database 120 is for example a data storage, which is provided in the first subscriber station 11. At first, additional information is selected from the database 120 at the first subscriber station 11 (Step 1). Now, control information is integrated in the CLI, for example information about plays or about a particularly defined ring tone (Step 2). Now, the call signaling takes place from the first subscriber station 11 to the second subscriber station 12, for example, a CLI with control information (Step 3).

The control information in the CLI is interpreted at the second subscriber station 12 (Step 4). Corresponding additional information is extracted from a database 121, which is assigned to the second subscriber station 12 or is provided in the second subscriber station 12. Here, the additional information corresponds to that additional information, which the subscriber A has selected at the first subscriber station 11 (Step 5). Now, the received ring tone corresponding to the additional information is played at the second subscriber station 12 in place of the preset ring tone (Step 6).

This form of the method also offers the possibility of an accurate invoicing since the control information, which is dispatched with the call signaling, can be evaluated at the switching device. In addition to that, no large data packets have to be transmitted for the execution of the transfer, e.g. ring tones etc., because of which the method can be implemented with relatively low expenditure.

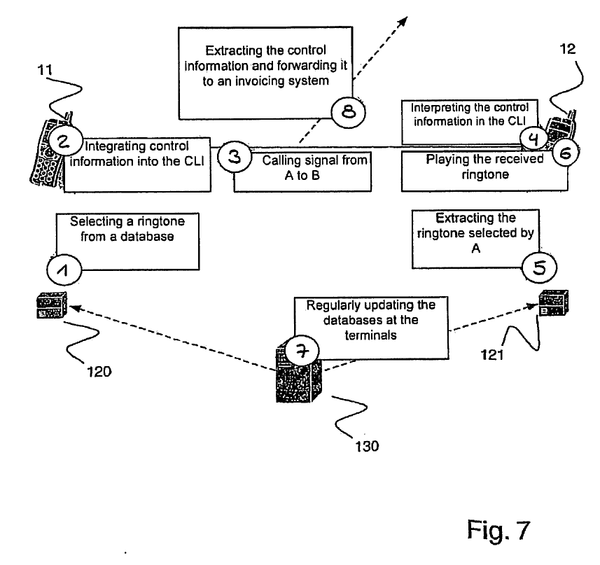

FIG. 7 shows a further advantageous form of the method according to the invention. This method corresponds in its process flow essentially to that shown in FIG. 6, whereas however a regular updating of the databases 120, 121 of the first or the second subscriber station 11, 12 occurs (Step 7). For that, the updates are transmitted from a data server 130 to the databases 120 or 121. Further, the extraction of the control information is represented in this figure, which occurs in a switching device. The control information is forwarded to an invoicing system (Step 8).

Always the latest ring tones or cards can be offered to the user through this form of the method according to the invention since the offer can be updated regularly via the data server 130. Further, an invoicing is possible since the control information, which is dispatched with the call signaling, can be evaluated at a switching device. In addition to that, no large data packets have to be transmitted between the subscriber stations 11, 12 for the execution of the process, so that the process can be implemented with relatively low expenditure.

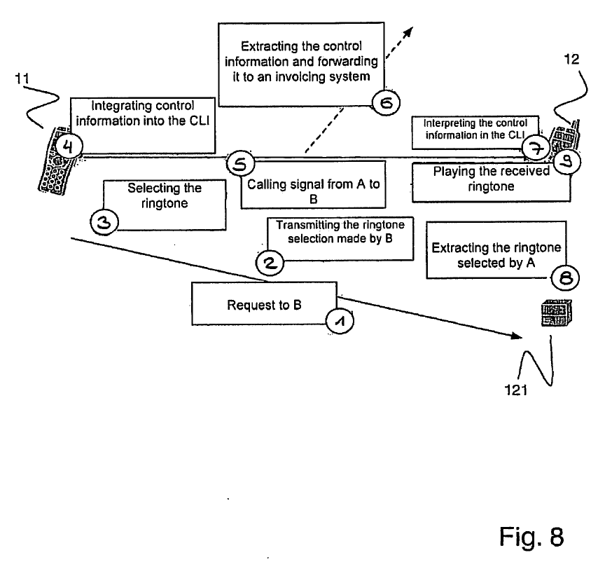

FIG. 8 shows especially a further advantageous embodiment of the method according to the invention. In this case, at first an inquiry takes place for the transmission of a ring tone selection, the inquiry starting from the first subscriber station 11 to the second subscriber station 12 (Step 1). Further to the inquiry, a transmission of the ring tone selection takes place from the second subscriber station 12 to the first subscriber station 11 (Step 2). Now, the selection of additional information from the repertoire of the second subscriber station 12 takes place at the first subscriber station 11 (Step 3).

Now, control information is integrated to the CLI at the first subscriber station 11, in which the control information, for example containing information about particular games or ring tones, videos, image files etc. (Step 4). Now, the call signaling takes place from the first subscriber station 11 to the second subscriber station 12, for example the CLI with the control information (Step 5). Besides, optionally, the extraction of the control information takes place in a switching device and the forwarding of the information to an invoicing system (Step 6).

The control information in CLI is interpreted in the second subscriber station 12 (Step 7). An additional information corresponding to that is extracted from the data storage 121 of the second subscriber station 12, which corresponds to the pre-selection made at the first subscriber station 11 (Step 8). Now, the playing of the received or the extracted ring tone takes place at the second subscriber station 12 instead of the preset ring tone (Step 9).

This process also offers the possibility of an accurate invoicing since the control information, which is dispatched with the call signaling, can be evaluated at the switching device. In this case also, no large data packets have to be transmitted so that the method can be implemented with a relatively low expenditure. In addition to that, the called subscriber at the subscriber station 12 can himself determine which type of ring tones he would like to hear.

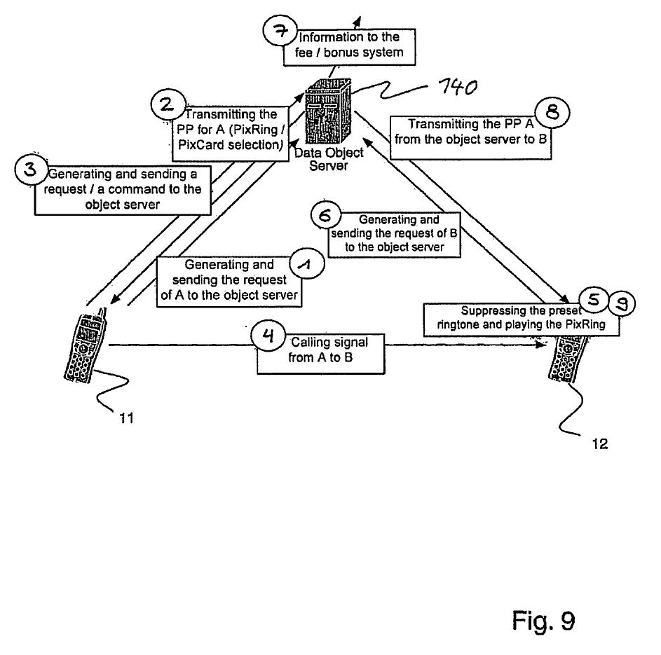

A further especially preferred form of the method is described based on FIG. 9. In this case, at first an inquiry is created at the first subscriber station 11, which is sent to an object data server 140. (Step 1). Afterwards, a selection of possible additional information is transmitted from the objects 140 to the first subscriber station 11 (Step 2). Now, a command is created at the first subscriber station 11, which is sent to the object data server 140 and which causes there the transmission of additional information to the second subscriber station 12 (Step 3).

Now, the call signaling takes place from the first subscriber station 11 to the second subscriber station 12 (Step 4). The preset ring tone is suppressed at the second subscriber station 12 and, instead of this, the additional information or the ring tone, which was transmitted from the object data server 140, is outputted (Step 5). Moreover, an inquiry takes place to the object data server 140, which is created by the second subscriber station 12 and sent to the object data server 140 (Step 6). Additionally, information arising from the object data server 140 is transmitted to a fee/bonus system (Step 7). The additional information is transmitted from the object data server 140 to the second subscriber station 12 (Step 8).

The individual process steps represented here are not linked to a particular sequence, but can also be executed in different sequences as per given conditions. Also, always the latest ring tones or cards can be offered to the user by this process since the offer is always retrieved from the object data server 140. Also, an accurate and proper invoicing is possible through this server-based system.

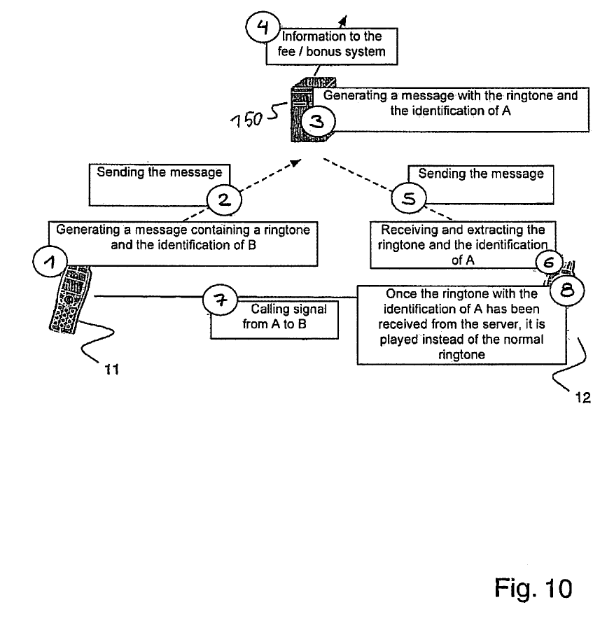

Finally, FIG. 10 shows a further possible embodiment of the method according to the invention. Here, at first, a message is created at the first subscriber station 11, for example an SMS or MMS. The message contains a ring tone and the number of the second subscriber station 12 (Step 1). The message is dispatched from the first subscriber station 11 to the object data server 150 (Step 2). Now, a message is created at the object data server 150, which contains the received ring tone and the identity of the first subscriber station 11 (Step 3).

In addition to that, there is a further possible embodiment of the method according to the invention. In this case, at first, an SMS or MMS message is created at the first subscriber station 11. The message contains an independent signal tone and the number of the first—sent—subscriber station 11 (Step 1). The message is dispatched via asynchronous SMS/MMS transmission channels and initiates retroactively a call of the subscriber B. If the call-back message is received by the subscriber B, the subscriber can view the transmitted call-back SMS of subscriber A. Thereby—automatically initiated by the opening of the callback message by subscriber 2—a direct callback setup to the subscriber A initiated through an additional device, occurs as well as an additional confirmation that the message was seen. The automatic callback function initiates the call setup to the subscriber A and can be identified with a callback ring tone there. The call charges are charged to subscriber A since he has initiated a call intend through the transmission of the call-back message and subscriber B is automatically connected to subscriber A by opening of the call-back message.

Further, information is forwarded to a charging/bonus system (Step 4). Finally, the dispatching of the created message occurs from the object data server 150 to the second subscriber station 12 (Step 5). The receipt and the extraction of the ring tone and the caller identity of the first subscriber station 11 occurs there (Step 6).

Proceeding from the first subscriber station 11, a call signaling of the first subscriber station 11 to the second subscriber station 12 occurs (Step 7). If the ring tone is received from the object data server 150 with the caller identity of the first subscriber station 11, this is outputted and played at the second subscriber station 12 instead of the standard ring tone (Step 8).

Already existing valid standards can be used also for this special form of the process for the call signaling and for the transmission of the ring tone. The invoicing of such calls with additional information can be implemented through a specific tax metering. Further, it is possible to implement the call with the contained additional information as service provider or to operate an own server, which implements the messages.

1-21. (canceled)

22. A communications method for transmitting additional information relating to a calling process, the method comprising:
using a first subscriber station to set up a communication context with a second subscriber station for a transmission of at least one of data and information;
defining additional information using the first subscriber station, the additional information including at least one of audio, image, video and control data;
transmitting the additional information to the second subscriber station before or during the calling process; and
outputting the additional information at the second subscriber station as a signal for a display of a call.

23. The method according to claim 22, wherein the additional information is transmitted from the first subscriber station to the second subscriber station

24. The method according to claim 22, wherein the additional information is retrieved, from a data storage linked to the second subscriber station, through a control signal outgoing from the first subscriber station.

25. The method according to claim 22, wherein the additional information is selected from stored templates using the first subscriber station.

26. The method according to claim 22, wherein the additional information is created by the first subscriber station.

27. The method according to claim 22, wherein the additional information is modified by the first subscriber station, so as to transmit individual messages of the first subscriber station in the additional information.

28. The method according to claim 22, further comprising:
automatically checking whether display of additional information is permitted or prevented before outputting the additional information at the second subscriber station.

29. The method according to claim 22, further comprising:
storing the additional information in a data storage assigned to the second subscriber station and outputting the additional information at the second subscriber station for future calls.

30. The method according to claim 22, further comprising the steps of:
outputting the additional information as a purchase offer at the second subscriber station; and,
sending a signal for accepting the purchase offer from the second subscriber station to a central data processing unit of a communication system.

31. The method according to claim 30, further comprising:
generating a signal to activate the additional information for use by the second subscriber station after sending the signal for accepting the purchase offer.

32. The method according to claim 30, further comprising:
generating a tariff reduction signal and assigning the reduction signal to the second subscriber station after sending the signal for accepting the purchase offer.

33. The method according to claim 22, further comprising:
transmitting a call signaling to the second subscriber station; and,
wherein the additional information is transmitted to the second subscriber station by data transfer before the call signaling.

34. The method according to claim 22, further comprising:
transmitting a call signaling to the second subscriber station; and,
wherein the additional information is transmitted to the second subscriber station by data transfer together with the call signaling.

35. The method according to claim 22, further comprising:
transmitting a control signal to the second subscriber station in the call signaling; and,
interpreting the control signal at the second subscriber station using a comparator so as to permit or prevent outputting the additional information at the second subscriber station.

36. The method according to claim 35, wherein the control signal is extracted in a switching device and transmitted to an invoicing system.

37. The method according to claim 22, further comprising:
transmitting a call signaling to the second subscriber station;
transmitting a control signal to the second subscriber station with the call signaling;
evaluating the control signal at the second subscriber station so as to select at least one of audio, image and video data from a data storage; and,
wherein the additional data includes the selected data.

38. The method according to claim 22, wherein at least one additional information is stored in at least one of the first and the second subscriber stations, the additional information being updated at timely intervals through a central data server of a communication system.

39. The method according to claim 37, further comprising:
sending a query signal to the second subscriber station, which causes the transmission of a selection information to the first subscriber station, before transmitting the control signal to the second subscriber station;
performing a selection using the first subscriber station for the selection of at least one of audio, image, and video information from the selection information; and,
transmitting a control signal corresponding to the selection to the second subscriber station.

40. The method according to claim 22, further comprising:
sending an inquiry signal from the first subscriber station to a central data server of the communication system, and
transmitting the additional information from a central data server to the second subscriber station.

41. The method according to claim 40, further comprising:
transmitting a selection signal from the central data server to the first subscriber station, after being triggered by receipt of the inquiry signal at the central data server, thereby enabling the selection of an additional information for the second subscriber station;
sending a trigger signal, after the step of transmitting a selection signal, for triggering the transmission of the selected additional information from the first subscriber station to the central data server, wherein the trigger signal effects transmitting the additional information to the second subscriber station.

42. The method according to claim 40, further comprising:
transmitting a call signaling to the second subscriber station;
sending the additional information from the central data server to the second subscriber station together with an identity of the first subscriber station;
sending a call signaling from the first subscriber station to the second subscriber station; and,
wherein outputting the additional information at the second subscriber occurs after receiving the call signaling at the second subscriber station.
